(19) United States
(12) Patent Application Publication
(10) Pub. No.: US 2026/0160121 A1
(43) Pub. Date: Jun. 11, 2026

(54) CORNER CONNECTORS FOR CORNER JOINTS OF FRAMED ASSEMBLIES

(71) Applicant: Arconic Technologies LLC, Pittsburgh, PA (US)

(72) Inventors: Jasimine Taylor FERRARER, Glendora, CA (US); Gabriel Seth GREEN, Atlanta, GA (US); Emma Morgan KALIF, Middletown, RI (US); Sarah Christiane KEMP, Mt. Airy, MD (US); Erica Christine LULL, Marshville, NC (US); Olukayode IYUN, Lawrenceville, GA (US); Christopher SCHULTZ, Norcross (CA); Ion-Horatiu BARBULESCU, Marietta, GA (US)

(73) Assignee: Arconic Technologies LLC, Pittsburgh, PA (US)

(21) Appl. No.: 19/179,825

(22) Filed: Apr. 15, 2025

Related U.S. Application Data
(60) Provisional application No. 63/637,302, filed on Apr. 22, 2024.

(51) Int. Cl. E06B 3/964; F16B 7/18; F16B 12/50

(52) U.S. Cl. CPC E06B 3/9644; F16B 7/18; F16B 12/50

(57) ABSTRACT

A corner joint of a framed assembly includes a stile providing opposing first and second lateral sides, and an interior web extending between the first and second lateral sides and providing a stile profile, a rail providing opposing first and second lateral sides, and an interior web extending between the first and second lateral sides of the rail and providing a rail profile, and a corner connector. The corner connector includes a first portion that provides a first connector profile matable with the stile profile, and a second portion extending from the first portion and providing a second connector profile matable with the rail profile.

### BACKGROUND

Commercial and residential buildings commonly include metal doors that include a pair of vertical side frame members or “stiles” interconnected by top and bottom horizontal frame members or “rails.” The stiles and rails are typically hollow, rectangular tubes made from rolled sheet metal, extruded aluminum, or an extruded polymer. The stiles and rails are often welded together at interconnecting joints to form a stable, structurally sound framed assembly that serves as the foundation for the door.

While welding is a common and effective method of joining metal components, it presents certain challenges. One issue is that this welding process is laborious, costly, and time consuming, which can lead to bottlenecks in production of framed assemblies. In addition, the welding process is highly dependent upon operator skill, which can cause varying degrees of quality at the joints. Finally, the stiles and rails are typically welded into the larger framed assembly at a location remote from the end use location (e.g. the commercial or residential building), such as in a manufacturing facility, which presents certain challenges when shipping the framed assembly to the end use location, such as the amount of space occupied within a delivery vehicle.

Accordingly, systems and methods for connecting stiles and rails together in a manner that is fast, easy, and can be done by a user at the end use location are desirable.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a corner joint of a framed assembly that includes a stile providing opposing first and second lateral sides and an interior web extending between the first and second lateral sides and providing a stile profile, a rail providing opposing first and second lateral sides and an interior web extending between the first and second lateral sides of the rail and providing a rail profile, and a corner connector including a first portion that provides a first connector profile matable with the stile profile and a second portion extending from the first portion and providing a second connector profile matable with the rail profile. In a further embodiment, the corner joint includes one or more first apertures defined in the interior web of the stile, one or more second apertures defined on the first connector profile and alignable with the one or more first apertures when the first connector profile is mated with the stile profile, one or more first mechanical fasteners extendable through the one or more first and second apertures to secure the corner connector to the stile, one or more third apertures defined in the interior web of the rail, one or more fourth apertures defined on the second connector profile and alignable with the one or more third apertures when the second connector profile is mated with the rail profile, and one or more second mechanical fasteners extendable through the one or more third and fourth apertures to secure the corner connector to the rail. In another further embodiment, the stile and the rail each define an interior, and the first portion is received within the interior of the stile to mate the first connector profile with the stile profile, and the second portion is received within the interior of the rail to mate the second connector profile with the rail profile. In another further embodiment, the first connector profile protrudes from the first portion and provides a first planar surface and first grooves provided on opposing sides of the first planar surface, and the second connector profile protrudes from the second portion and provides a second planar surface and second grooves provided on opposing sides of the second planar surface. In another further embodiment, the first portion provides a first exterior surface opposite the first connector profile, the second portion provides a second exterior surface opposite the second connector profile, and the corner joint further includes a first exterior web opposite the interior web of the stile and extending between the first and second lateral sides of the stile, a second exterior web opposite the interior web of the rail and extending between the first and second lateral sides of the rail, one or more first apertures defined on the first exterior web, one or more second apertures defined on the first exterior surface and alignable with the one or more first apertures when the first connector profile is mated with the stile profile, one or more third apertures defined on the second exterior web, and one or more fourth apertures defined on the second exterior surface and alignable with the one or more third apertures when the second connector profile is mated with the rail profile. In another further embodiment, a notch is defined in the interior web of the stile and the second portion extends through the notch when the first portion is received within the interior of the stile. In another further embodiment, the second portion provides an exterior surface opposite the second connector profile, and the corner joint further includes an exterior web opposite the interior web of the rail and extending between the first and second lateral sides of the rail and a spacer arrangeable within the interior of the rail between the exterior surface of the second portion and the exterior web of the rail. In another further embodiment, the corner joint further includes one or more first apertures defined on the exterior surface, one or more second apertures defined on a top surface of the spacer and alignable with the one or more first apertures when the spacer is received within the interior of the rail, one or more first mechanical fasteners extendable through the one or more first and second apertures to secure the spacer to the corner connector, one or more third apertures defined on the exterior web, one or more fourth apertures defined on a bottom surface of the spacer and alignable with the one or more third apertures when the spacer is received within the interior of the rail, and one or more second mechanical fasteners extendable through the one or more third and fourth apertures to secure the corner connector to the rail. In another further embodiment, the interior web of the stile includes opposing arms that extend away from the interior web of the stile and toward one another to co-operatively define a channel sized to receive the first connector profile. In another further embodiment, the rail profile is a first rail profile and the corner connector is a first corner connector, and the corner joint further includes an exterior web opposite the interior web of the rail and extending between the first and second lateral sides of the rail, the exterior web of the rail providing a second rail profile, and a second corner connector, the first and second corner connectors each including the first portion providing the first connector profile and receivable within the channel of the stile profile and the second portion extending from the first portion and providing the second connector profile, wherein the second connector profile of the first corner connector is matable with the first rail profile, and wherein the second connector profile of the second corner connector is matable with the second rail profile. In another further embodiment, the first connector profile of each corner connector is receivable within the stile profile and vertically offset from each other. In another further embodiment, the corner joint further includes one or more first apertures defined in the interior web of the stile, one or more second apertures defined on the first connector profile of the first corner connector and alignable with the one or more first apertures when the first connector profile of the first corner connector is mated with the stile profile, one or more first mechanical fasteners extendable through the one or more first and second apertures to secure the first corner connector to the stile, one or more third apertures defined in the interior web of the stile and vertically offset from the one or more first apertures, one or more fourth apertures defined on the first connector profile of the second corner connector and alignable with the one or more third apertures when the first connector profile of the second corner connector is mated with the stile profile, and one or more second mechanical fasteners extendable through the one or more third and fourth apertures to secure the second corner connector to the stile. In another further embodiment, the corner joint further includes one or more first apertures defined on the interior web of the rail, one or more second apertures defined on the second connector profile of the first corner connector and alignable with the one or more first apertures when the first connector profile of the first corner connector is received within the first rail profile, one or more third apertures defined on the exterior web of the rail, and one or more fourth apertures defined on the second connector profile of the second corner connector and alignable with the one or more third apertures when the second connector profile of the second corner connector is received within the second rail profile. In another further embodiment, the first rail profile provides a first pair of arms that extend away from the interior web and toward one another to co-operatively define a first slot for receiving the first portion of the first corner connector, and the second rail profile provides a second pair of arms that extend away from the exterior web and toward one another to co-operatively define a second slot for receiving the second portion of the second corner connector.

Embodiments disclosed herein include a method assembling a corner joint of a framed assembly including providing a stile having opposing first and second lateral sides, and an interior web extending between the first and second lateral sides and defining a stile profile, providing a rail having opposing first and second lateral sides, and an interior web extending between the first and second lateral sides of the rail and defining a rail profile, advancing a first portion of a corner connector into the stile profile and thereby mating a first connector profile of the corner connector with the stile profile, and advancing a second portion of the corner connector into the rail profile and thereby mating a second connector profile of the corner connector with the rail profile. In a further embodiment, one or more first apertures are defined in the interior web of the stile, one or more second apertures are defined on the first connector profile, one or more third apertures are defined in the interior web of the rail, and one or more fourth apertures are defined on the second connector profile, the method further including aligning the one or more first and second apertures, securing the corner connector to the stile with one or more first mechanical fasteners extending through the one or more first and second apertures, aligning the one or more third and fourth apertures, and securing the corner connector to the rail with one or more second mechanical fasteners extending through the one or more third and fourth apertures. In another further embodiment, the stile and the rail each define an interior, the method further including receiving the first portion within the interior of the stile to mate the first connector profile with the stile profile, and receiving the second portion within the interior of the rail to mate the second connector profile with the rail profile. In another further embodiment, the second portion provides an exterior surface opposite the second connector profile, and an exterior web extends between the first and second lateral sides of the rail opposite the interior web of the rail, the method including positioning a spacer within the interior of the rail between the exterior surface of the second portion and the exterior web of the rail, securing the spacer to the corner connector with one or more first mechanical fasteners, and securing the corner connector to the rail with one or more second mechanical fasteners. In another further embodiment, the corner connector is a first corner connector, and the method further includes advancing a first portion of a second corner connector into the stile profile and thereby mating a first connector profile of the second corner connector with the stile profile. In another further embodiment, the rail profile is a first rail profile, and an exterior web extends between the first and second lateral sides of the rail opposite the interior web of the rail, the method further including advancing a second portion of the second corner connector into a second rail profile and provided on the exterior web of the rail and thereby mating the second connector profile of the second corner connector with the second rail profile.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a front view of an example framed assembly that may incorporate one or more principles of the present disclosure.

FIGS. 2A-2B are perspective and exploded views, respectively, of an example corner joint that may incorporate the principles of the present disclosure.

FIG. 2C is a perspective view of the stile of FIGS. 2A-2B, according to at least one aspect of the present disclosure.

FIG. 2D is a perspective view of the rail of FIGS. 2A-2B, according to at least one aspect of the present disclosure.

FIG. 3 is a perspective view of another example corner joint, according to one or more additional embodiments of the present disclosure.

FIGS. 4A and 4B are isometric and exploded views, respectively, of another example corner assembly, according to one or more additional embodiments of the present disclosure.

FIG. 4C is a perspective view of an example corner connector, in accordance with at least one aspect of the present disclosure.

FIG. 4D is a perspective view of the stile of FIGS. 4A-4B, according to at least one aspect of the present disclosure.

FIG. 4E is a perspective view of the rail of FIGS. 4A-4B, according to at least one aspect of the present disclosure.

### DETAILED DESCRIPTION

The present disclosure is generally related to framed assemblies for fenestrations, like doors and windows, and, more particularly, to corner connectors that interconnect horizontal and vertical frame members at a corner joint.

The embodiments discussed herein provide systems and methods for assembling stiles and rails into a framed assembly without welded connections. The systems and methods provided herein simplify and expedite the assembly process, while allowing the assembly process to be performed at the end use location, rather than at a manufacturing facility.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure. However, it will be understood that these terms are used for convenience and ease of description only and are not intended to limit the disclosure to any particular orientation.

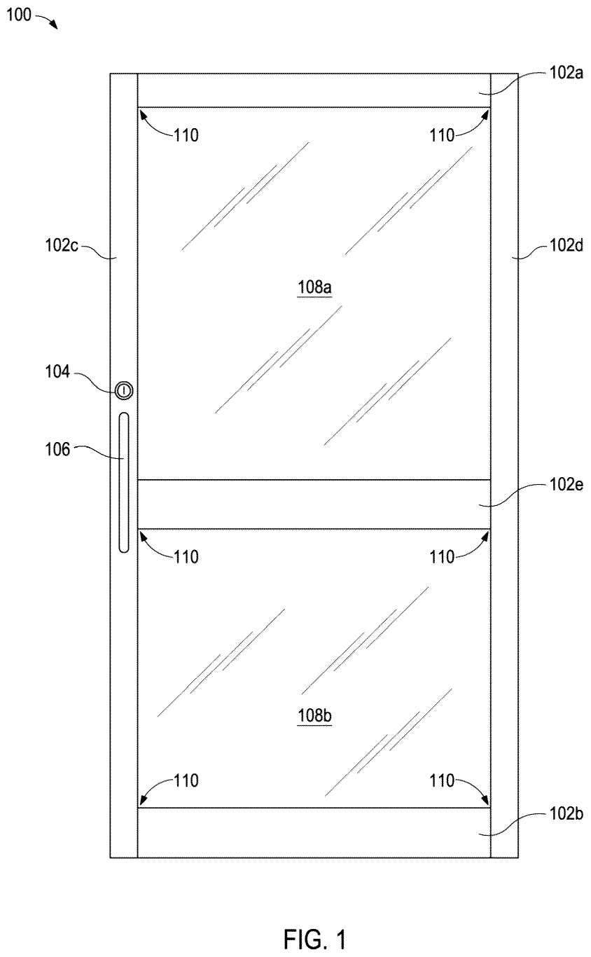

FIG. 1 is a front view of an example framed assembly 100 that may incorporate one or more principles of the present disclosure. In the illustrated embodiment, the framed assembly 100 comprises a door that may be employed in any commercial or residential building setting. The principles of the present disclosure, however, may be equally applicable to other types of framed assemblies including, but not limited to, doorframes, windows, window vents, window frames, glazing panels (alternately referred to as “glazing units”), curtain walls, storefronts, skylights, or any combination thereof. Accordingly, while the following discussion is directed to a door framed assembly, other types of framed assemblies may equally incorporate the presently disclosed features.

As illustrated, the framed assembly 100 includes a plurality of frame members, shown as a top frame member 102a, a bottom frame member 102b, and opposing side frame members 102c and 102d extending between the top and bottom frame members 102a,b. An optional intermediate frame member 102e may extend between the side frame members 102c,d at an intermediate location. The top, bottom, and intermediate frame members 102a,b,e are alternately referred to as horizontally-extending “rails,” and the side frame members 102c,d are alternately referred to as vertically-extending “stiles.” Accordingly, the top, bottom, and intermediate frame members 102a,b,e will be referred to herein as rails 102a,b,e, and the side frame members 102c,d will be referred to herein as first and second stiles 102c,d.

The rails and stiles 102a-e may comprise hollow, generally rectangular tubes made of a variety of rigid materials including, but not limited to, aluminum, rolled sheet metal, a polymer, a composite material (e.g., fiberglass, carbon fiber, etc.), or any combination thereof. In the illustrated embodiment, the left stile 102c includes conventional door hardware, such as a lock 104 and a door handle 106.

The rails and stiles 102a-e cooperatively surround and otherwise “frame” first and second center panels 108a and 108b, alternately referred to as “infill” panels. While two center panels 108a,b are depicted, more or fewer than two may be employed, without departing from the scope of the disclosure. In some embodiments, the center panels 108a,b may each comprise glass lites and, in at least one embodiment, may comprise double paned glass including air, an inert gas, and/or a plastic film(s) between adjacent panes to control transmission of thermal energy. In other embodiments, however, the center panels 108a,b may alternatively comprise other types of infills such as, but not limited to, a glazing panel, polycarbonate, or another clear, translucent, tinted, or opaque panel, without departing from the scope of the disclosure.

The ends of each rail 102a,b,e are joined to the adjacent stiles 102c,d at corresponding corner joints 110. As illustrated, the rails and stiles 102a-e may be arranged generally orthogonal to one another at the corner joints 110. In other applications, however, the angular offset between the interconnected adjacent rails and stiles 102 a-e may be greater or less than 90°, without departing from the scope of the disclosure.

The rails and stiles 102a-e are typically welded together at the corner joints 110 to form the framed assembly 100. However, welding at the corner joints 110 is laborious, costly, and time consuming. According to embodiments of the present disclosure, a corner connector (not shown) may be included in the framed assembly 100 at one or more of the corner joints 110 to help connect intersecting rails 102a,b,e and stiles 102c,d. The corner connector connects the rails and stiles 102a-e without welding and in a manner that is fast and easy, and that can be done by a user at the end use location.

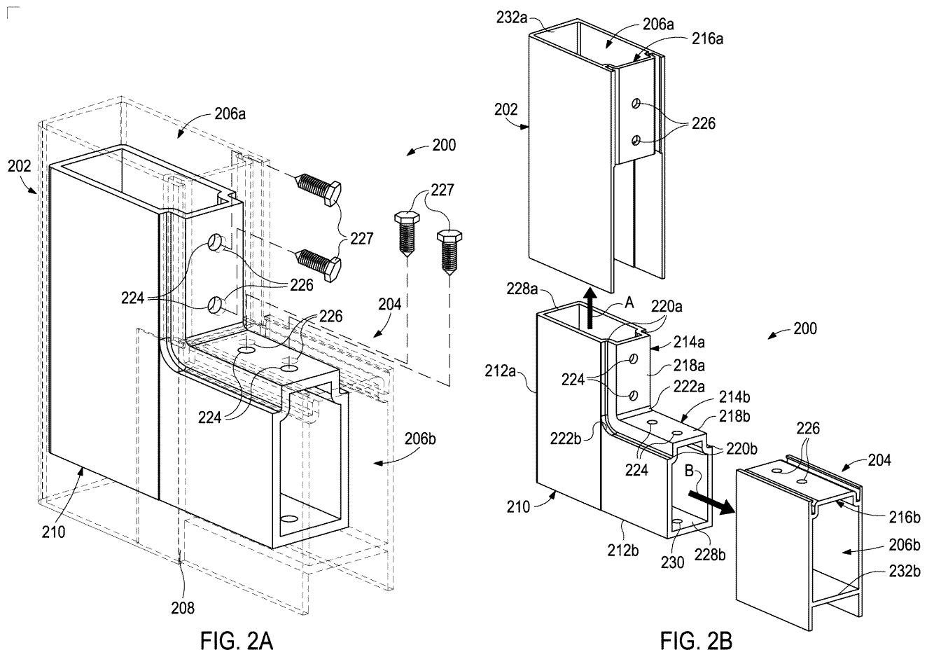

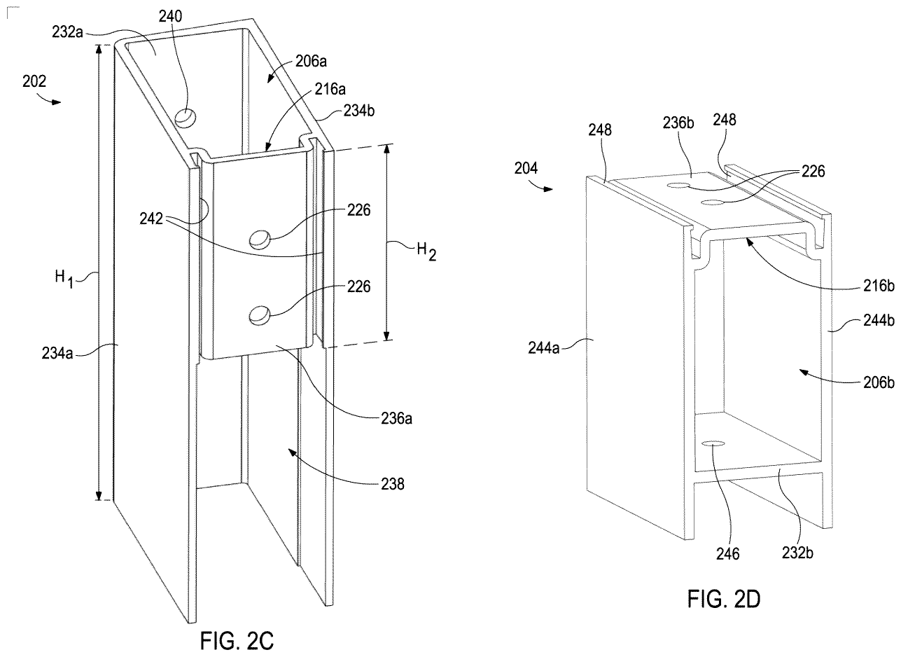

FIGS. 2A and 2B are perspective and exploded views, respectively, of an example corner joint 200 that may incorporate the principles of the present disclosure. The corner joint 200 may be the same as or representative of any of the corner joints 110 shown in FIG. 1 and, therefore, may form part of the framed assembly 100 (FIG. 1). As illustrated, the corner joint 200 includes the intersection of a stile 202 and a rail 204, which are shown in FIG. 2A in phantom. The stile 202 may be the same as or similar to either of the stiles 102c,d (FIG. 1), and the rail 204 may be the same as or similar to any of the rails 102a,b,e (FIG. 1).

As illustrated, the stile 202 and the rail 204 each comprise hollow, generally rectangular structures. The stile 202 provides an interior or “cavity” 206a, and the rail 204 provides an interior or “cavity” 206b that communicates with the interior 206a when the stile 202 and the rail 204 are brought into engagement with each other and form a seam 208 (FIG. 2A).

The corner joint 200 further includes a corner connector 210 that may be received at least partially within the interior 206a,b of each of the stile 202 and the rail 204 to help secure the interconnecting stile 202 and rail 204 without welds. Referring to FIG. 2B, the corner connector 210 may be L-shaped and include a first or “vertical” portion 212a and a second or “horizontal” portion 212b extending from the first portion 212 a at about 90°. The angle between the vertical and horizontal portions 212 a,b, however, may be greater or less than 90°, without departing from the scope of the disclosure.

The corner connector 210 may be made of a variety of materials including a metal (e.g., aluminum, an aluminum alloy, steel, a steel alloy, etc.), a polymer (e.g., nylon, polypropylene, polyetherimide, polycarbonate, polystyrene, etc.), a composite material (e.g., fiberglass, carbon fiber, etc.), or any combination thereof. The corner connector 210 may be manufactured via casting, extruding, injection molding, stamping, machining, additive manufacturing (i.e., 3D printing), or any combination thereof.

In some embodiments, the corner connector 210 may comprise a monolithic structure. In such embodiments, the first and second portions 212a,b form a unitary structure. In other embodiments, however, the first and second portions 212a,b may be manufactured separately and then coupled together via a variety of joining methods including, but not limited to, one or more mechanical fasteners (e.g., nails, screws, rivets, etc.), an adhesive, welding, brazing, an interference fit, or any combination thereof.

Still referring to FIG. 2B, when assembling the corner joint 200, the vertical portion 212a is received within the interior 206a of the stile 202, as indicated by the arrow A, and the horizontal portion 212b is received within the interior 206b of the rail 204, as indicated by the arrow B. The vertical portion 212a provides or otherwise defines a first or “vertical” connector profile 214a matable with a corresponding stile profile 216a provided by the stile 202 and, more particularly, within the interior 206a of the stile 202. The horizontal portion 212b similarly provides or otherwise defines a second or “horizontal” connector profile 214b matable with a corresponding rail profile 216b provided by the rail 204 and, more particularly, within the interior 206b of the rail 204.

The vertical and horizontal connector profiles 214a,b and the corresponding stile and rail profiles 216a,b may exhibit a variety of designs and geometries, without departing from the scope of this disclosure. In the illustrated embodiment, the connector profiles 214a,b protrude from the vertical and horizontal portions 212a,b, respectively, such that the vertical and horizontal portions 212a,b define a rectangular cross-sectional profile with a raised feature. The vertical connector profile 214a provides a vertical planar surface 218a matable with a corresponding planar surface defined by the stile profile 216a, and the horizontal connector profile 214b provides a horizontal planar surface 218b matable with a corresponding planar surface defined by the rail profile 216b. Moreover, in some embodiments, the vertical connector profile 214a may define vertical grooves 220a provided on opposing sides of the vertical planar surface and sized to mate with a corresponding one or more vertical grooves defined by the stile profile 216a. Similarly, the horizontal connector profile 214b may define horizontal grooves 220b provided on opposing sides of the horizontal planar surface and sized to mate with a corresponding one or more horizontal grooves defined by the rail profile 216b.

In some embodiments, a first transition surface 222a is defined and otherwise provides a transition between the vertical and horizontal planar surfaces 218a,b, and a second transition surface 222b is defined and otherwise provides a transition between the vertical and horizontal grooves 220a,b. The transition surfaces 222a,b may facilitate ease of manufacturing and may additionally help the corner joint 200 bear load when the panels 108a,b (FIG. 1) are installed. In some embodiments, as illustrated, the transition surfaces 222a,b may be curved or arcuate, but could alternatively provide sharp corners, without departing from the scope of the disclosure.

Each connector profile 214a,b defines one or more apertures 224 configured to align with a corresponding one or more apertures 226 defined in the stile 202 and the rail 204, respectively, when the vertical and horizontal portions 212a,b are received within the corresponding interiors 206a,b of the stile 202 and rail 204. FIG. 2A shows the apertures 224, 226 aligned as the corner connector 210 is properly received within the stile 202 and the rail 204. With the apertures 224, 226 aligned, corresponding mechanical fasteners 227, such as screws or bolts, may be advanced through the aligned apertures 224, 226 to secure the corner connector 210 to the stile 202 and rail 204, and thereby secure the stile 202 to the rail 204.

In at least one embodiment, rear wall or exterior surfaces 228a and 228b of the vertical and horizontal portions 212a,b, respectively, may also define one or more additional apertures 230 (only one aperture 230 in the exterior surface 228b is visible). The additional apertures 230 in the exterior surfaces 228a,b may be configured to align with corresponding apertures (not shown) defined in opposing exterior webs 232a and 232b of the stile 202 and the rail 204, respectively. Once the additional apertures 230 are aligned with the apertures in the exterior webs 232a,b, corresponding mechanical fasteners (not shown), such as screws or bolts, may be advanced through the aligned apertures to help further secure the corner connector 210 to the stile 202 and rail 204.

FIG. 2C is a perspective view of the stile 202, in accordance with at least one aspect of the present disclosure. As illustrated, the stile 202 includes opposing first and second lateral sides 234a and 234b, and the exterior web 232a extends between the first and second lateral sides 234a,b. The stile 202 further includes an interior web 236a opposite the exterior web 232a and also extending between the first and second lateral sides 234a,b. The interior web 236a may alternately be referred to herein as a “mounting plate”. The lateral sides 234a,b and the exterior web 232a may exhibit a first height H₁ and the interior web 236a may exhibit a second height H₂ smaller than the first height H₁. Accordingly, the interior web 236a extends only partially along the length of the lateral sides 234a,b such that a notch 238 is defined in the stile 202. The notch 238 may be sized to receive the horizontal portion 212b (FIG. 2B) when the corner connector 210 (FIGS. 2A-2B) is received within the stile 202. Said differently, the horizontal portion 212b extends through the notch 238 and out of the interior 206a of the stile 202 when the vertical portion 212a is received within the interior 206a. Alternatively, the first height H₁ and the second height H₂ may be the same, or substantially the same.

The interior web 236a defines the apertures 226 and, as illustrated, the exterior web 232a may define one or more additional apertures 240 (one visible). As briefly described above, the additional apertures 240 may be configured to align with corresponding apertures 230 (FIG. 2B) provided in the exterior surface 228a (FIG. 2B) of the vertical portion 212a (FIG. 2B) of the corner connector 210 (FIG. 2B). Once the additional apertures 240 are aligned with the apertures 230 in the exterior surface 228a, corresponding mechanical fasteners, such as screws or bolts, may be advanced through the aligned apertures to help secure the corner connector 210 to the stile 202.

The interior web 236a may be the same as or define the stile profile 216a provided within the interior 206a of the stile 202 and configured to mate with the vertical connector profile 214a (FIG. 2B), as described above. The corresponding geometry of the stile profile 216a and the vertical connector profile 214a allows the vertical connector profile 214a to slidably engage the stile profile 216a when the vertical portion 212a (FIG. 2B) of the corner connector 210 (FIG. 2B) is received within the interior 206a of the stile 202.

In some embodiments, as illustrated, the interior web 236a may provide or define slots 242 configured to help matably attach the stile 202 to a panel, such as panel 108a,b (FIG. 1).

FIG. 2D is a perspective view of the rail 204, in accordance with at least one aspect of the present disclosure. As illustrated, the rail 204 includes opposing first and second lateral sides 244a,b, and the exterior web 232b extends between the lateral sides 244a,b. As illustrated, the exterior web 232b may be raised vertically (e.g., vertically offset) relative to a bottom surface of the lateral sides 244a,b such that the exterior web 232b is displaced from (does not touch) the ground/floor. The rail 204 further includes an interior web 236b opposite the exterior web 232b and also extending between the first and second lateral sides 244a,b. The interior web 236b may alternately be referred to herein as a “mounting plate”.

The interior web 236b defines the apertures 226 and, as illustrated, the exterior web 232b may define one or more additional apertures 246 (two visible). The additional apertures 246 may be configured to align with the corresponding apertures 230 provided in the exterior surface 228b (FIG. 2B) of the horizontal portion 212b (FIG. 2B) of the corner connector 210 (FIG. 2B), as briefly mentioned above. Once the additional apertures 246 are aligned with the apertures 230 in the exterior web 232b, corresponding mechanical fasteners, such as screws or bolts, may be advanced through the aligned apertures 230, 246 to help secure the corner connector 210 to the rail 204.

The interior web 236b may be the same as or define the rail profile 216b provided within the interior 206b of the rail 204 and configured to mate with the horizontal connector profile 214b (FIG. 2B), as described above. The corresponding geometry of the rail profile 216b and the horizontal connector profile 214b allows the horizontal connector profile 214b to slidably engage the rail profile 216b when the horizonal portion 212b (FIG. 2B) of the corner connector 210 (FIG. 2B) is received within the interior 206b of the rail 204.

In some embodiments, as illustrated, the interior web 236b may provide or define slots 248 configured to help matably attach the rail 204 to a panel, such as panel 108a,b (FIG. 1).

Referring again to FIG. 2B, with continued reference to FIGS. 2C and 2D, a method of assembling the corner joint 200 will now be described. The vertical portion 212a of the corner connector 210 may be inserted (positioned) within the interior 206a of the stile 202, as shown by the arrow A. As the vertical portion 212a advances into the interior 206a, the vertical connector profile 214a, including the vertical planar surface 218a and corresponding vertical grooves 220a, will mate with and slidably engage the stile profile 216a. The vertical portion 212a may be advanced into the interior 206a until the apertures 224 defined in the vertical planar surface 218a align with the corresponding apertures 226 defined in the interior web 236a. Advancing the vertical portion 212a into the interior 206a will also allow the apertures 240 defined in the exterior web 232a to align with corresponding apertures provided in the exterior surface 228a of the corner connector 210. With the various apertures aligned as discussed above, corresponding mechanical fasteners (e.g., mechanical fasteners 227) may be inserted through the aligned apertures to secure the corner connector 210 to the stile 202.

The corner connector 210 may be coupled to the rail 204 in a substantially similar fashion. In particular, the horizontal portion 212b of the connector 210 may be inserted (positioned) within the interior 206b of the rail 204, as shown by the arrow B. As the horizontal portion 212b advances into the interior 206b, the horizontal connector profile 214b, including the horizontal planar surface 218b and corresponding horizontal grooves 220b, will mate with and slidably engage the rail profile 216b. The horizontal portion 212b may be advanced into the interior 206b until the apertures 224 defined in the horizontal planar surface 218b align with the corresponding apertures 226 in the interior web 236b. Advancing the horizontal portion 212b into the interior 206b will also allow the apertures 246 defined in the exterior web 232b to align with the corresponding apertures 230 provided in the exterior surface 228a of the corner connector 210. With the various apertures 224, 226 and 230, 246 aligned as discussed above, corresponding mechanical fasteners (e.g., mechanical fasteners 227) may be inserted through the aligned apertures 224, 226 and 230, 246 to secure the corner connector 210 to the rail 204.

Accordingly, the corner joint 200 enables a framed assembly 100 (FIG. 1) to be assembled fast, easy, and by a user at the end use location without the need for welding. By allowing the frame to be assembled by a user at the end use location, the stiles, rails, and corner connectors can be shipping deconstructed (uncoupled), which may reduce the amount of space occupied by the components of the framed assembly 100 in the delivery vehicle during shipping.

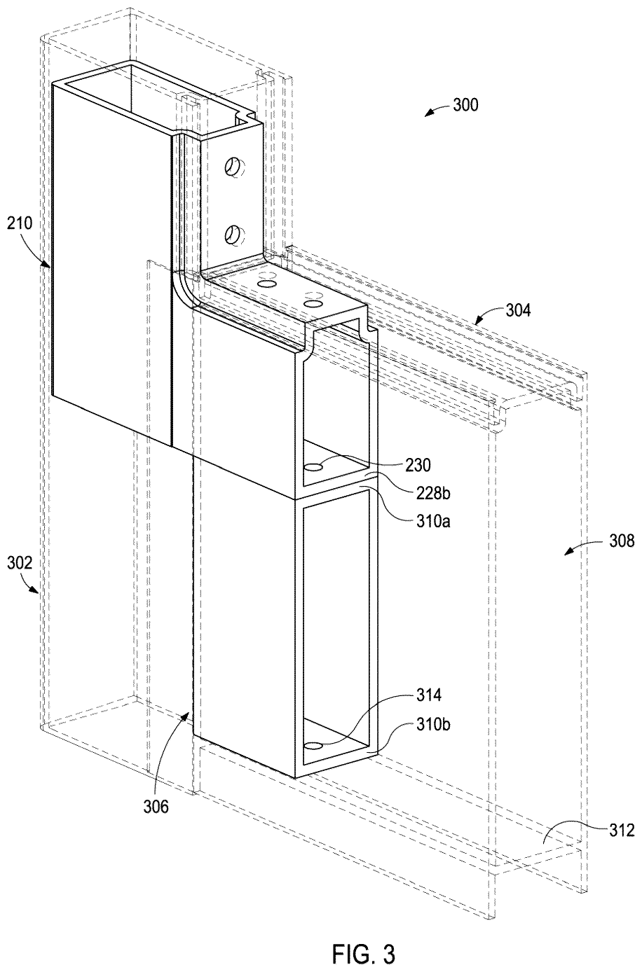

FIG. 3 is a perspective view of another example corner joint 300, according to one or more additional embodiments. Similar to the corner joint 200 of FIGS. 2A-2B, the corner joint 300 may be the same as or representative of any of the corner joints 110 shown in FIG. 1 and, therefore, may form part of the framed assembly 100 (FIG. 1). As illustrated, the corner joint 300 includes the intersection of a stile 302 and a rail 304, which are shown in FIG. 3 in phantom. The stile 302 may be the same as or similar to either of the stiles 102c,d (FIG. 1), and the rail 304 may be the same as or similar to any of the rails 102a,b,e (FIG. 1). Moreover, similar to the corner joint 200, the corner joint 300 may include the corner connector 210 received at least partially within corresponding interiors of the stile 302 and the rail 304 to help secure the interconnecting stile 302 and rail 304 without welds.

Unlike the corner joint 200, however, the rail 304 of the corner joint 300 is larger (i.e., taller) than the rail 204 of FIGS. 2A, 2B, 2D. More specifically, the rail 304 has a height greater than the height of the rail 204. To accommodate for the increased height, the corner joint 300 may further include a spacer 306, which may help provide a more rigid coupling for the corner connector 210. As illustrated, the spacer 306 may be arranged within an interior 308 of the rail 304 and generally located vertically below the corner connector 210.

More specifically, the spacer 306 may exhibit a generally rectangular shape that includes a top surface 310a and a bottom surface 310b opposite the top surface 310a. The spacer 306 may be inserted within the interior 308 such that the top surface 310a abuts (contacts) the bottom of the exterior surface 228b of the corner connector 210, and the bottom surface 310b abuts (contacts) an exterior web 312 of the rail 304, thereby filling a vertical gap between the exterior surface 228b and the exterior web 312 of the rail 304.

The top and bottom surfaces 310a, b may each define one or more apertures 314 (only one aperture 314 in the bottom surface 310b is visible). The apertures 314 provided in the upper surface 310a are configured to align with corresponding apertures 230 provided in the exterior surface 228b of the corner connector 210 (FIG. 2B), and the apertures 314 provided in the bottom surface 310b are configured to align with corresponding apertures (not shown) defined in the exterior web 312 of the rail 304. Once the various apertures are aligned, corresponding mechanical fasteners (e.g., mechanical fasteners 227 of FIG. 2A) may be used to secure the corner connector 210, the spacer 306, and the rail 304 together.

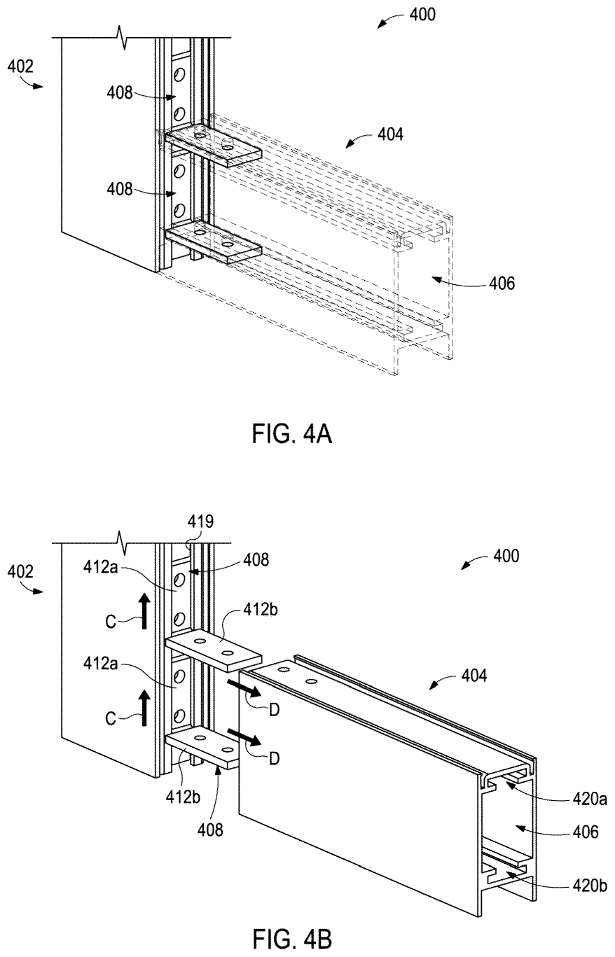

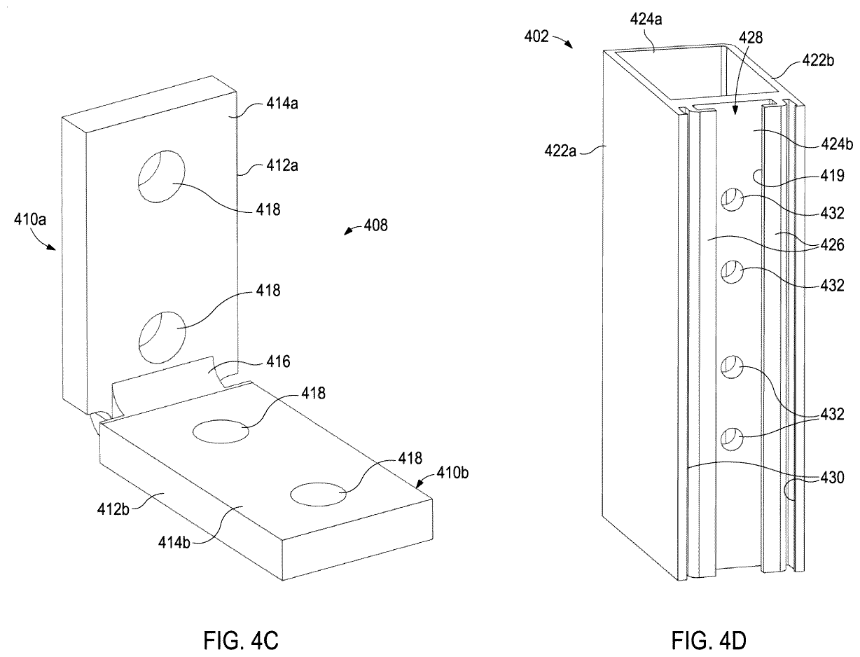

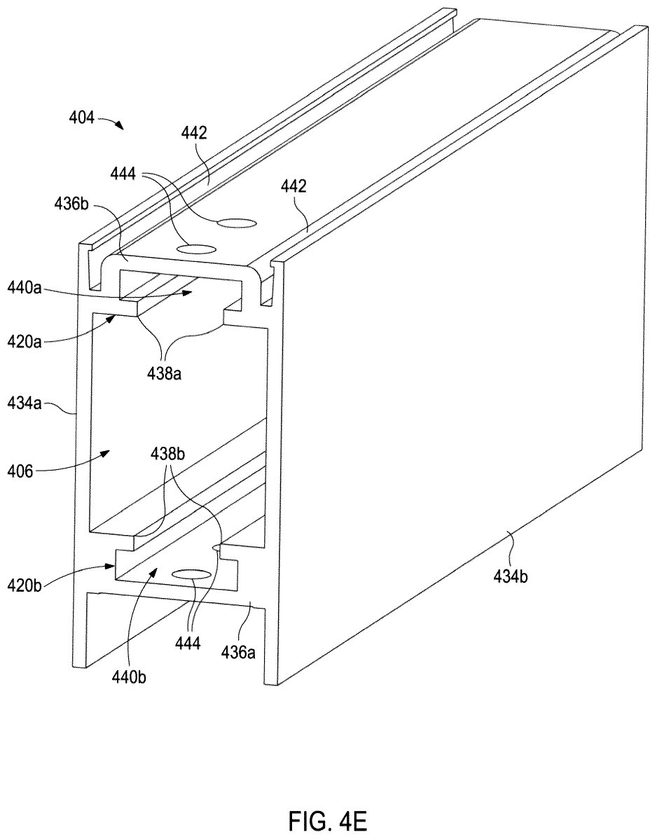

FIGS. 4A and 4B are isometric and exploded views, respectively, of another example corner joint 400, according to one or more additional embodiments of the present disclosure. The corner joint 400 may be the same as or representative of any of the corner joints 110 shown in FIG. 1 and, therefore, may form part of the framed assembly 100 (FIG. 1). As illustrated, the corner joint 400 includes the intersection of a stile 402 and a rail 404 (shown in phantom in FIG. 2A). The stile 402 may be the same as or similar to either of the stiles 102c,d (FIG. 1), and the rail 404 may be the same as or similar to any of the rails 102a,b,e (FIG. 1). The stile 402 and the rail 404 each comprise hollow, generally rectangular structures, and at least the rail 404 provides an interior 406.

The corner joint 400 includes one or more corner connectors 408 configured to help secure the interconnecting stile 402 and rail 404 without welds. In the illustrated embodiment, two corner connectors 408 are included in the corner joint 400, but more or less than two may be included, without departing from the scope of the disclosure. As illustrated, at least a portion of each corner connector 408 is received within the interior 406 of the rail 404.

Referring briefly to FIG. 4C, illustrated is a perspective view of an example corner connector 408. As illustrated, the corner connector 408 may be L-shaped and include a first or “vertical” portion 410a and a second or “horizontal” portion 410 b extending from the first portion 410 a at about 90°. The angle between the vertical and horizontal portions 410 a,b, however, may be greater or less than 90°, without departing from the scope of the disclosure. The corner connector 408 may be made of any of the materials mentioned above with reference to the corner connector 210 (FIGS. 2A-2B). The corner connector 408 may be fabricated into an L-shape using various manufacturing techniques, including stamping, rolling, cutting, bending, or any combination thereof.

The vertical portion 410a provides or otherwise defines a first or “vertical” connector profile 412a and the horizontal portion 410b provides or otherwise defines a second or “horizontal” connector profile 412b. As described below, the vertical connector profile 412a may be matable with a corresponding stile profile, and the horizontal connector profile 412b may be matable with a corresponding rail profile. The vertical and horizontal connector profiles 412a,b may exhibit a variety of designs and geometries, without departing from the scope of the disclosure. In the illustrated embodiment, each connector profile 412a,b defines a generally rectangular cross-sectional shape. Moreover, the vertical connector profile 412a provides a vertical planar surface 414a, and the horizontal connector profile 412b provides a horizontal planar surface 414b.

A transition surface 416 may be defined and otherwise provide a transition between the vertical and horizontal portions 410a,b. As illustrated, the transition surface 416 may be curved or arcuate, but could alternatively provide a sharp corner. The transition surface 416 may facilitate ease of manufacturing and may additionally help the corner assembly 400 to bear load when the panels 108a,b (FIG. 1) are installed.

Each connector profile 412a,b defines one or more apertures 418 configured to align with corresponding apertures defined in the stile 402 (FIGS. 4A-4B) and the rail 404 (FIGS. 4A-4B), respectively, when the corner joint 400 (FIGS. 4A-4B) is assembled. With the apertures aligned, corresponding mechanical fasteners (e.g., mechanical fasteners 227 of FIG. 2A) can extend through the aligned apertures to secure the corner connector 408 to the stile 402 and the rail 404, and thereby secure the stile 402 to the rail 404.

Referring again to FIGS. 4A-4B and, more particularly to FIG. 4B, the vertical connector profile 412a of each corner connector 408 may be matable with a corresponding stile profile 418 provided on the stile 402. In the illustrated embodiment, the stile 402 provides a single stile profile 418, and each vertical connector profile 412a is configured to be received within the same stile profile 418, but arranged vertically offset from each other.

Referring briefly to FIG. 4D, illustrated is a perspective view of the stile 402, in accordance with at least one aspect of the present disclosure. As illustrated, the stile 402 includes opposing first and second lateral sides 422 a and 422b, and an exterior web 424a extends between the first and second lateral sides 422a,b. The stile 402 also includes an interior web 424b opposing the exterior web 424a and also extending laterally between the first and second lateral sides 422a,b. The interior web 424 b, alternately referred to as the “mounting plate 424b,” may be the same as or define the stile profile 418 configured to mate with the vertical connector profiles 412a (FIG. 4B), as described above. The corresponding geometry of the stile profile 418 and the vertical connector profiles 412a allows the vertical connector profiles 412a to slidably engage the stile profile 418 when the vertical portion 410a (FIG. 4C) of each corner connector 408 (FIGS. 4A-4C) is received within the stile profile 418. In at least one embodiment, for example, the mounting plate 424b may include or otherwise define opposing flanges or arms 426 that extend away from the mounting plate 424b and toward one another to co-operatively define a slot or channel 428 sized to receive the vertical portions 410a of each corner connector 408 and, more particularly, the vertical connector profiles 412a of each corner connector 408.

The mounting plate 424b and the lateral sides 422a,b may also co-operatively define receiving areas or slots 430 that may each receive at least a portion of a panel, such as panel 108a,b (FIG. 1). The mounting plate 424b may define one or more apertures 432 alignable with the apertures 418 (FIG. 4C) defined in the vertical portion 410a (FIG. 4C) of each corner connector 408 (FIGS. 4A-4C). Once the apertures 418, 432 are aligned, corresponding mechanical fasteners (e.g., mechanical fasteners 227 of FIG. 2A) may be extended therethrough to secure the corner connectors 408 to the stile 402.

Referring again to FIGS. 4A-4B and, more particularly to FIG. 4B, the rail 404 may provide or otherwise define corresponding first and second rail profiles 420a and 420b vertically offset from each other within the interior 406 of the rail 404. The horizontal connector profile 412b of each corner connector 408 is matable with a corresponding one of the rail profiles 420a,b.

Referring briefly to FIG. 4E, illustrated is a perspective view of the rail 404, in accordance with at least one aspect of the present disclosure. As illustrated, the rail 404 includes opposing first and second lateral sides 434a and 434b, and an exterior web 436a extends between the lateral sides 434a,b. As illustrated, the exterior web 436a may be raised vertically (e.g., vertically offset) relative to a bottom surface of the lateral sides 434a,b such that the exterior web 436a is displaced from (does not touch) the ground/floor. The rail 404 may also include an interior web 436b opposite the exterior web 436a and also extending between the lateral sides 434a,b. The interior web 436b may alternately be referred to herein as a “mounting plate 436b”.

The interior web 436b and the exterior web 436a may be the same as or form part of the first and second rail profiles 420a and 420b, respectively, each being provided within the interior 406 of the rail 404 and configured to mate with a corresponding horizontal connector profile 412b (FIGS. 4B-4C) of one of the corner connectors 408 (FIGS. 4A-4C), as described above. The corresponding geometry of the rail profiles 420a,b and the horizontal connector profiles 412b allows the horizontal connector profiles 412b to slidably engage the corresponding rail profile 420a,b when the horizonal portion 410b (FIG. 4C) of the corner connector 408 is received within the interior 406 of the rail 404.

In particular, the rail profiles 420a,b are generally C-shaped and inverted (mirrored) relative to one another. The upper rail profile 420a may include a first pair of flanges or arms 438a that extend away from the mounting plate 436b and toward one another to co-operatively define a first horizontal cavity or slot 440a for receiving a horizontal portion 410b (FIG. 4C) of one of the corner connectors 408 (FIGS. 4A-4C). Similarly, the lower rail profile 420b may include a second pair of flanges or arms 438b that extend away from the exterior web 436a and toward one another to co-operatively define a second horizontal cavity or slot 440b for receiving a horizontal portion 410b of the other corner bracket 408.

The interior web 436b and the lateral sides 422a,b may co-operatively define receiving areas or slots 442 that may each receive at least a portion of a panel, such as panel 108a,b (FIG. 1).

The exterior web 436a and the interior web 436b may each define one or more apertures 444. When the horizontal portion 410b (FIG. 4C) of the corner connectors 408 (FIGS. 4A-4C) are received within the rail profiles 420 a,b, the apertures 418 (FIG. 4C) defined on the horizontal portion 410b may align with the apertures 444 provided in the webs 436a,b. Once the apertures 418, 444 are aligned, corresponding mechanical fasteners (e.g., mechanical fasteners 227 of FIG. 2A) may be advanced through the aligned apertures 418, 444 to help secure the corner connector 408 to the rail 404.

Referring again to FIG. 4B, with continued reference to FIGS. 4C-4E, a method of assembling the corner joint 400 is now provided. The vertical portion 410a of each corner connector 408 may be inserted (positioned) upwardly through the vertical slot 428 of the stile 402, as shown by the arrow C (FIG. 4B). As the vertical portions 410a are advanced into the vertical slot 428, the vertical connector profile 412a of each corner connector 408, including the vertical planar surface 414a, will mate with and slidably engage the stile profile 418. The vertical portions 410a,b may be advanced into the vertical slot 428 until the apertures 418 align with corresponding apertures 432 in the mounting plate 424b. With the apertures 418, 432 aligned, corresponding mechanical fasteners (e.g., mechanical fasteners 227 of FIG. 2A) may be inserted through each of the aligned apertures 418, 432 to secure the corner connectors 408 to the stile 402, vertically offset from each other.

The first and second corner connectors 408 may be coupled to the rail 404 in a substantially similar fashion. In particular, the horizontal portions 410b of each connector 408 may be inserted (positioned) within the horizontal slots 440a,b of the rail 404, as shown by arrows D. As the horizontal portions 410b are advanced into the corresponding horizontal slots 440a,b, the horizontal connector profile 412a,b, including the horizontal planar surfaces 414b, will mate with and slidably engage the corresponding rail profiles 420a,b. The horizontal portions 410b may be advanced into the corresponding slots 440a,b until the apertures 418 of the horizontal portions 410b align with corresponding apertures 444 in the exterior and interior webs 436a,b. With the apertures 418, 444 aligned, corresponding mechanical fasteners (e.g., mechanical fasteners 227 of FIG. 2A) may be inserted through each of the aligned apertures 418, 444 to secure the corner connectors 408 to the rail 404.

Accordingly, the corner joint 400 enables a framed assembly 100 (FIG. 1) to be assembled fast, easy, and by a user at the end use location. By allowing the framed to be assembled by a user at the end use location, the stiles, rails, and corner bodies can be shipping deconstructed (uncoupled), which may reduce the amount of space occupied by the components of the framed assembly 100 in the delivery vehicle during shipping.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A corner joint of a framed assembly, comprising:
a stile providing opposing first and second lateral sides, and an interior web extending between the first and second lateral sides and providing a stile profile;
a rail providing opposing first and second lateral sides, and an interior web extending between the first and second lateral sides of the rail and providing a rail profile; and
a corner connector including:
a first portion that provides a first connector profile matable with the stile profile; and
a second portion extending from the first portion and providing a second connector profile matable with the rail profile.

2. The corner joint of claim 1, further comprising:
one or more first apertures defined in the interior web of the stile;
one or more second apertures defined on the first connector profile and alignable with the one or more first apertures when the first connector profile is mated with the stile profile;
one or more first mechanical fasteners extendable through the one or more first and second apertures to secure the corner connector to the stile;
one or more third apertures defined in the interior web of the rail;
one or more fourth apertures defined on the second connector profile and alignable with the one or more third apertures when the second connector profile is mated with the rail profile; and
one or more second mechanical fasteners extendable through the one or more third and fourth apertures to secure the corner connector to the rail.

3. The corner joint of claim 1, wherein the stile and the rail each define an interior, and wherein the first portion is received within the interior of the stile to mate the first connector profile with the stile profile, and the second portion is received within the interior of the rail to mate the second connector profile with the rail profile.

4. The corner joint of claim 3, wherein the first connector profile protrudes from the first portion and provides a first planar surface and first grooves provided on opposing sides of the first planar surface, and wherein the second connector profile protrudes from the second portion and provides a second planar surface and second grooves provided on opposing sides of the second planar surface.

5. The corner joint of claim 3, wherein the first portion provides a first exterior surface opposite the first connector profile, and the second portion provides a second exterior surface opposite the second connector profile, the corner joint further comprising:
a first exterior web opposite the interior web of the stile and extending between the first and second lateral sides of the stile;
a second exterior web opposite the interior web of the rail and extending between the first and second lateral sides of the rail;
one or more first apertures defined on the first exterior web;
one or more second apertures defined on the first exterior surface and alignable with the one or more first apertures when the first connector profile is mated with the stile profile;
one or more third apertures defined on the second exterior web; and
one or more fourth apertures defined on the second exterior surface and alignable with the one or more third apertures when the second connector profile is mated with the rail profile.

6. The corner joint of claim 3, wherein a notch is defined in the interior web of the stile and the second portion extends through the notch when the first portion is received within the interior of the stile.

7. The corner joint of claim 3, wherein the second portion provides an exterior surface opposite the second connector profile, the corner joint further comprising:
an exterior web opposite the interior web of the rail and extending between the first and second lateral sides of the rail; and
a spacer arrangeable within the interior of the rail between the exterior surface of the second portion and the exterior web of the rail.

8. The corner joint of claim 7, further comprising:
one or more first apertures defined on the exterior surface;
one or more second apertures defined on a top surface of the spacer and alignable with the one or more first apertures when the spacer is received within the interior of the rail;
one or more first mechanical fasteners extendable through the one or more first and second apertures to secure the spacer to the corner connector;
one or more third apertures defined on the exterior web;
one or more fourth apertures defined on a bottom surface of the spacer and alignable with the one or more third apertures when the spacer is received within the interior of the rail; and
one or more second mechanical fasteners extendable through the one or more third and fourth apertures to secure the corner connector to the rail.

9. The corner joint of claim 1, wherein the interior web of the stile includes opposing arms that extend away from the interior web of the stile and toward one another to co-operatively define a channel sized to receive the first connector profile.

10. The corner joint of claim 9, wherein the rail profile is a first rail profile and the corner connector is a first corner connector, the corner joint further comprising:
an exterior web opposite the interior web of the rail and extending between the first and second lateral sides of the rail, the exterior web of the rail providing a second rail profile; and
a second corner connector, the first and second corner connectors each including:
the first portion providing the first connector profile and receivable within the channel of the stile profile; and
the second portion extending from the first portion and providing the second connector profile,
wherein the second connector profile of the first corner connector is matable with the first rail profile, and
wherein the second connector profile of the second corner connector is matable with the second rail profile.

11. The corner joint of claim 10, wherein the first connector profile of each corner connector is receivable within the stile profile and vertically offset from each other.

12. The corner joint of claim 11, further comprising:
one or more first apertures defined in the interior web of the stile;
one or more second apertures defined on the first connector profile of the first corner connector and alignable with the one or more first apertures when the first connector profile of the first corner connector is mated with the stile profile;
one or more first mechanical fasteners extendable through the one or more first and second apertures to secure the first corner connector to the stile;
one or more third apertures defined in the interior web of the stile and vertically offset from the one or more first apertures;
one or more fourth apertures defined on the first connector profile of the second corner connector and alignable with the one or more third apertures when the first connector profile of the second corner connector is mated with the stile profile;
one or more second mechanical fasteners extendable through the one or more third and fourth apertures to secure the second corner connector to the stile.

13. The corner joint of claim 10, further comprising:
one or more first apertures defined on the interior web of the rail;
one or more second apertures defined on the second connector profile of the first corner connector and alignable with the one or more first apertures when the first connector profile of the first corner connector is received within the first rail profile;
one or more third apertures defined on the exterior web of the rail; and
one or more fourth apertures defined on the second connector profile of the second corner connector and alignable with the one or more third apertures when the second connector profile of the second corner connector is received within the second rail profile.

14. The corner joint of claim 10, wherein the first rail profile provides a first pair of arms that extend away from the interior web and toward one another to co-operatively define a first slot for receiving the first portion of the first corner connector, and
wherein the second rail profile provides a second pair of arms that extend away from the exterior web and toward one another to co-operatively define a second slot for receiving the second portion of the second corner connector.

15. A method of assembling a corner joint of a framed assembly, comprising:
providing a stile having opposing first and second lateral sides, and an interior web extending between the first and second lateral sides and defining a stile profile;
providing a rail having opposing first and second lateral sides, and an interior web extending between the first and second lateral sides of the rail and defining a rail profile;
advancing a first portion of a corner connector into the stile profile and thereby mating a first connector profile of the corner connector with the stile profile; and
advancing a second portion of the corner connector into the rail profile and thereby mating a second connector profile of the corner connector with the rail profile.

16. The method of claim 15, wherein one or more first apertures are defined in the interior web of the stile, one or more second apertures are defined on the first connector profile, one or more third apertures are defined in the interior web of the rail, and one or more fourth apertures are defined on the second connector profile, the method further comprising:
aligning the one or more first and second apertures;
securing the corner connector to the stile with one or more first mechanical fasteners extending through the one or more first and second apertures;
aligning the one or more third and fourth apertures; and
securing the corner connector to the rail with one or more second mechanical fasteners extending through the one or more third and fourth apertures.

17. The method of claim 15, wherein the stile and the rail each define an interior, the method further comprising:
receiving the first portion within the interior of the stile to mate the first connector profile with the stile profile; and
receiving the second portion within the interior of the rail to mate the second connector profile with the rail profile.

18. The method of claim 15, wherein the second portion provides an exterior surface opposite the second connector profile, and an exterior web extends between the first and second lateral sides of the rail opposite the interior web of the rail, the method comprising:
positioning a spacer within the interior of the rail between the exterior surface of the second portion and the exterior web of the rail;
securing the spacer to the corner connector with one or more first mechanical fasteners; and
securing the corner connector to the rail with one or more second mechanical fasteners.

19. The method of claim 15, wherein the corner connector is a first corner connector, and the method further comprises advancing a first portion of a second corner connector into the stile profile and thereby mating a first connector profile of the second corner connector with the stile profile.

20. The method of claim 19, wherein the rail profile is a first rail profile, and an exterior web extends between the first and second lateral sides of the rail opposite the interior web of the rail, the method further comprising:
advancing a second portion of the second corner connector into a second rail profile and provided on the exterior web of the rail and thereby mating the second connector profile of the second corner connector with the second rail profile.
